(19) United States
(12) Patent Application Publication
(10) Pub. No.: US 2005/0171458 A1
(43) Pub. Date: Aug. 4, 2005

(54) Chair mountable, low frequency transducer

(76) Inventors: Mark A. Luden, Westerville, OH (US); Marvin L. Clamme, New Knoxville, OH (US); Jonathon M. Katz, Solon, OH (US); William L. Watts, Crestwood, KY (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/025,260

(22) Filed: Dec. 29, 2004

Related U.S. Application Data
(60) Provisional application No. 60/533,298, filed on Dec. 30, 2003.

(51) Int. Cl. A61H 1/00

(52) U.S. Cl. 601/49; 601/59

(57) ABSTRACT

A manually mountable and demountable low frequency transducer apparatus for generating low frequency vibrations in a chair or other furniture. A clamp, preferably manually operable, is attached to one end of a support arm and a vibrating transducer motor (vibrator) is attached to the opposite end so the transducer motor is supported in cantilever relation from a leg of the article of furniture. Preferably the arm has a length substantially within the range of 1 inch to 12 inches and the jaws of the clamp are oppositely concave so the transducer apparatus is mounted with the vibrator having a vertical axis of vibration. The mass and the arm may be designed to be resonant or near the operating frequency of the vibrator.

### CROSS-REFERENCES TO RELATED APPLICATIONS

This application claims the benefit of U.S. Provisional Application No. 60/533,298 filed Dec. 30, 2003.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to vibrating transducers which are used to generate vibrations in the low audio frequency range and below in order to enhance the realism of sound reproduction or to simulate vibration-generating events and more particularly relates to a structure for mounting the transducers to a chair or other furniture. The invention is particularly useful with personal computer and online gaming and for digital music playback, such as with MP3 files played on a computer.

2. Description of the Related Art

Vibrating transducers for transducing the low frequency portion of electronic signals have been attached to building structures, such as a floor, or to furniture, such as a theater chair, for reproducing low frequency audio signals in order to enhance the realism of reproduced sound as well as for reproducing or synthesizing the vibrations from physical events, such as a collision. The prior art shows such transducers, for example in U.S. Pat. No. 5,973,422, which is herein incorporated by reference. Typically, when such a vibrator is attached to a chair, it is attached directly to the underside of or within the seat of the chair. This is done on the theory that this placement locates the vibrator in the position closest to the human body part which is most firmly in contact with the chair and will do most of the sensing of the vibrations. However, this placement sometimes causes an unrealistic distribution of the vibrations making them overly concentrated directly upon the posterior of the human occupant of the chair.

Transducers of this type can also improve the experience of computer gaming and entertainment, and the reproduction of music and other sounds. Users can feel low frequency vibrations without making the room too loud and risking ear damage using a sound system.

There is a need, however, for a vibrating transducer combined with a mounting structure so that the transducer can conveniently be attached to a chair in a manner which is durable and attains highly effective operation of the transducer in imparting vibrations to the chair so the mechanical vibrations that are generated by the transducer will be realistically perceived by a person seated in the chair. The mounting structure needs to provide effective and efficient coupling of the energy of the mechanical oscillations to the chair so the chair will be vibrated at a sufficiently large amplitude. The structure also needs to be easy to install, to remain tightly in position without vibrating loose as a result of usage and yet be easy to remove for installation on another chair. The device needs to efficiently couple the vibration energy from the vibrator to the chair in a manner that drives the chair at a significant vibratory amplitude and in a direction and mode of vibration which are highly effective in simulating the effect of the low frequency sounds and other vibrations.

### BRIEF SUMMARY OF THE INVENTION

The invention is the combination of a clamp, preferably manually operable, an arm attached to and extending from the clamp and a vibrating transducer motor attached to the arm, preferably at the end of the arm opposite the clamp. Preferably the arm has a length substantially within the range of 1 inch to 12 inches, more preferably within the range of 4 inch to 10 inches and most preferably within the range of 6 inches to 7 inches. Preferably, the jaws of the clamp are oppositely concave so that the axis of vibration of the vibrator can be predetermined to be vertical. The preferred clamping arrangement has V-shaped jaws, one fixed to the arm and a second jaw pivotally mounted in the manner of a hinge to the arm at a side of the first jaw. The vibrating mass and the effective spring constant of the arm may be designed to be resonant at or near the operating frequency of the vibrator.

### BRIEF DESCRIPTION OF THE SEVERAL VIEWS OF THE DRAWINGS

FIG. 1 is a view in perspective of the preferred embodiment of the invention.

FIG. 2 is an exploded, perspective view of the embodiment illustrated in FIG. 1.

FIG. 3 is a view in side elevation of a pedestal chair having an embodiment of the low frequency transducer of the invention mounted to its pedestal.

FIGS. 4-7 are views in perspective of alternative embodiments of the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

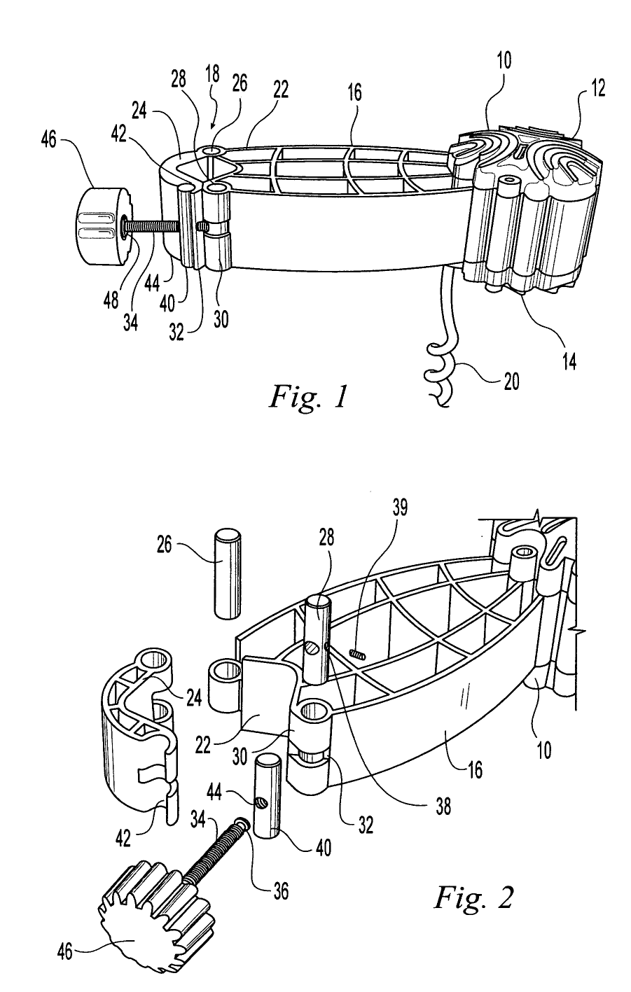

The preferred embodiment of the invention is illustrated in FIGS. 1 and 2 and has a vibrating motor, referred to as the vibrator, contained within a housing 10 and therefore not visible. The vibrator may be of the type illustrated in U.S. Pat. No. 5,973,422. Preferably, the housing 10 has heat dissipating cooling fins 12 and 14 formed on its exterior. The housing 10 is fixed to one end of an arm 16 and a clamp assembly 18 is fixed to the opposite end of the arm 16. A wire 20 extends from the vibrator for supplying the electrical driving power and signal for driving the reciprocating mass of the vibrator in its mechanical oscillation. Except for the wire 20, the housing 10, the arm 20 and the clamp assembly 18 are essentially vertically symmetrical and therefore a bottom view is essentially a mirror image of the top visible in FIG. 1.

The clamp assembly 18 is designed to engage a vertical post or leg, such as a leg of a chair. It is particularly designed to engage and clamp to the central post or column of a pedestal chair. Since the post of most pedestal chairs is essentially cylindrical, the clamp assembly includes two V-shaped jaws 22 and 24. The jaw 22 is formed integrally with the arm 16 and the jaw 24 is pivotally mounted in the manner of a hinge to the arm 16 by means of a pivot pin 26 located at one side of the jaw 22. At the opposite side of the jaw 22 there is another pivot pin 28 pivotally mounted in a cylindrical sleeve 30, which is also fixed to the arm 16. A slot 32 is formed transversely through the cylindrical sleeve 30 so that a screw 34 can be rotatably engaged to the pivot pin 28 and is free to be moved circularly through an arc of at least 90° and preferably about 180°.

The screw 34 is not threadedly engaged to the pin 28 but rather is rotatable with respect to the pin 28. This is accomplished, as illustrated in FIG. 2, by providing an annular slot and shoulder 36 at the end of the screw 34 and a threaded, diametrical hole 38 through the pin 28 into which a retaining set screw 39 is threadedly engaged. The set screw 39 is turned to extend into the annular slot and shoulder 36 to prevent withdrawal of the screw 34 while at the same time allowing its rotation.

A third vice jaw pin 40 removably seats into a channel 42 formed at the end of the jaw 24. The vice jaw pin 40 has a threaded hole 44, which threadedly engages the screw 34. A manually actuable knob 46 is threadedly engaged to the end of the screw 34 and fixed to it by a jam nut 48 so that rotation of the knob 46 rotates the screw 34.

The clamp is opened by rotating the screw 34 in one direction causing the pin 40 to travel along the screw 34 and out of the channel 42. When the pin 40 is out of the channel, the screw 34 may be moved circularly to rotate the position of the pin 40 so that it extends laterally of the arm 16. This allows the jaw 24 to be pivoted away from the jaw 22 to open the clamp. The jaw 22 can then be seated against one side of a vertical post or column. After engagement of the jaw 22 against the vertical column, the jaw 24 is pivoted back and against the diametrically opposite side of the column. The screw 34 is then moved circularly to locate the pin 40 outwardly of the channel 42. The screw 34 is then rotated about its axis in the direction opposite the first rotation described above to cause the pin 40 to be displaced longitudinally along the screw 34, into the channel 42. Further tightening rotation of the screw 34 forces the pin 40 against the channel bottom thereby clamping the column of a chair between the jaws 22 and 24.

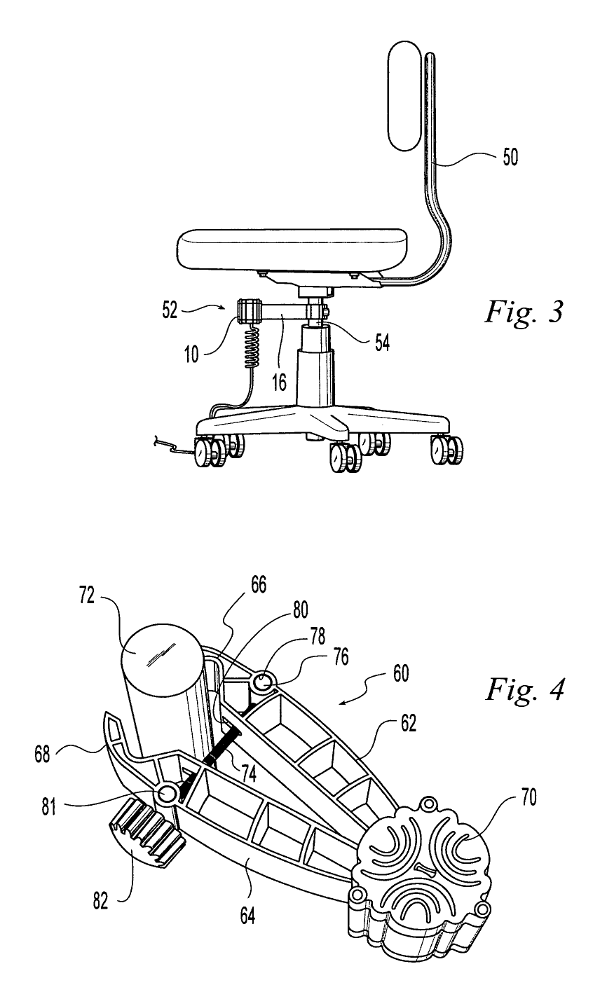

FIG. 3 illustrates a pedestal chair 50 that has been made a vibratory chair because a low frequency transducer apparatus 52 is clamped to its central post 54 which is its single chair leg. The clamp jaws 22 and 24 are clamped onto the post 54 so that the support arm 16, which is attached at one end to and extends from the clamp jaws 22 and 24, extends outwardly as a cantilever and has the vibrator within the housing 10 attached at the opposite end of the arm 16.

It is advantageous to have the V of the jaws run parallel to the axis of reciprocation of the vibrator, which are both illustrated as vertical. It is also advantageous that the arm have a sufficient length that it operates as a cantilever with the vibrator at its end so that there is a moment arm extending from the column of the chair to the axis of the vibrator. The reason for having a moment arm is that it is desirable to vibrate the seat of a chair in a mode that provides a significant component of vibratory motion in the horizontal plane. It is more difficult, that is it requires more power, to vibrate a chair in the vertical direction because the chair is restrained by the mass and resistance of the floor. However, the seat is not restrained in the horizontal direction and therefore has more freedom of motion; that is, less restraint. Consequently, vibrations of larger amplitude can more easily be accomplished in this mode of vibration.

V-shaped jaws are only one of several types of concave jaws that can be used to orient the axis of the clamp parallel to the axis of a post or leg so that the vibrator is attached to the leg with its axis of reciprocation parallel to the axis of the jaws. Therefore, the axis of vibration can be made parallel to the axis of the leg, typically vertically. Semicircular, arcuate and other concave contours can be used to assure that the clamp will be attached to a post or leg in a predetermined orientation so that the vibrations will have the preferred components described below.

By mounting the vibrator at the end of an arm and driving the vibrating mass in a vertical direction, the up and down reciprocation of the vibrator applies a torque component through the arm to the chair column and in alternating directions about a horizontal axis centered at the jaws. This torque is applied through the chair column to drive the chair seat in vibrations in the horizontal plane, either front to back or side to side depending upon whether the arm 16 extends forwardly or sidewardly of the chair. Of course the arm can extend in any radial direction and the same effect is attained. This torque component is in addition to the vertical component of vibration transmitted to the column from the vertical vibration of the vibrator at the end of the arm.

Although the arm can be of any length, as the arm is made longer, the proportion of vibrator energy which is translated into vertical vibration of the chair is decreased and the proportion of vibrator energy which is translated into horizontal seat vibration as a result of the moment arm effect increases. Further, as the moment arm is made longer, the mechanical advantage of the longer moment arm is increased but the angular amplitude of the motion of the arm is decreased. Additionally, the moment arm should not be so long that the arm extends from beneath the chair seat or it will interfere with other objects, any person walking by or, if it were to extend from the front of the chair, with the person seated on the chair. For these reasons there is a range of preferred arm length. Of course, the power of the vibrator and/or its amplitude of vibration may be increased to at least partially offset any deterioration of performance from operating outside the preferred range of arm length.

Preferably, the arm extends forwardly of the chair column. It is also preferred that the arm be at least 1 inch long and preferably not more than 12 inches long. The length of the arm is most conveniently defined as the distance from the center of the jaws to the center of the vibrating mass of the vibrator. It is believed better that the arm is at least 2 inches long and more preferably 4 to 10 inches long. Most preferably, the arm is between 6 and 7 inches long. For a vibrator of the type illustrated in the patent cited above and having an amplitude of reciprocation of approximately 0.5 inch, the arm was made to position the center of the vibrating mass 6.349 inches from the center of the jaws and therefore from the center of the column of the chair.

Since the arm of the present invention, like essentially all bodies, has some resilience, it is possible to design the vibrating masses and the arm length and resilience in a bending direction to accomplish a broad (not sharp) bending mode resonance. The bending mode spring constant of the arm and the mass of the vibrator would be chosen to comply with the mathematical relationship for resonance that is well known in the field of physics. The frequency in that mathematical relationship would be in or near the operating, low frequency range of the vibrator. Although such a resonance would be very damped by the chair and its human occupant, embodiments of the invention may be optimized in this manner.

One advantage of the present invention arises because it has been found that mounting a vibrator directly to the seat of some chairs can cause localized vibrations, which may be unrealistic for some applications, and can cause some unwanted discomfort to a person sitting in the chair. By mounting the vibrator to a leg or the central post of a pedestal chair, the vibration is not localized but rather is distributed over the portions of the chair engaging the human body sitting in the chair. This also more closely simulates the experience of being in a music hall, near a collision or many other vibration-producing event.

Another advantage is that an embodiment of the invention can be mounted to the central column of a pedestal chair and positioned and oriented so that it does not interfere with the conventional chair structures for raising and lowering the chair. Additionally, if the chair is raised or lowered, the invention will continue to operate as designed without damaging either the chair or the invention.

Many variations and alternative embodiments of the invention are possible, especially in the clamp and support arm structures. FIGS. 4-7 illustrate a few such alternative embodiments.

FIG. 4 shows an embodiment in which the support arm 60 which is bifurcated into two pivotal arms 62 and 64 each of which carries a clamping jaw, 66 and 68 respectively. The arms 62 and 64 are pivoted to the vibrator housing 70. This can be accomplished by having two stacked rings that slidably surround the housing 70, with each ring fixed to a different arm. Alternatively, there can be two spaced pivots so the arms and the clamping jaws 66 and 68 can pivot into clamping engagement with the vertical chair leg or column 72. In order to enable the jaws 66 and 68 to be forced in clamping relationship onto the column 72, a threaded rod 74 is pivotally connected to a pin 76 that is rotatably mounted in the bore of a cylinder 78 formed in the arm 62. The rod 74 extends transversely from the pin 76 through a transverse slot 80 formed through the cylinder 78 and the arm 62. The rod 74 extends through and is threadedly engaged to a pin 80 mounted in the arm 64. The threaded rod 74 is fixed to a manually operable knob 82. Consequently, rotating the knob 82 and its attached threaded rod 74 in one direction tightens the arms 62 and 64 together to seat the clamping jaws 66 and 68 against the column 72. Rotating the knob 82 in the opposite direction moves the arms and jaws apart until they are far enough apart to move the entire embodiment from the column 72.

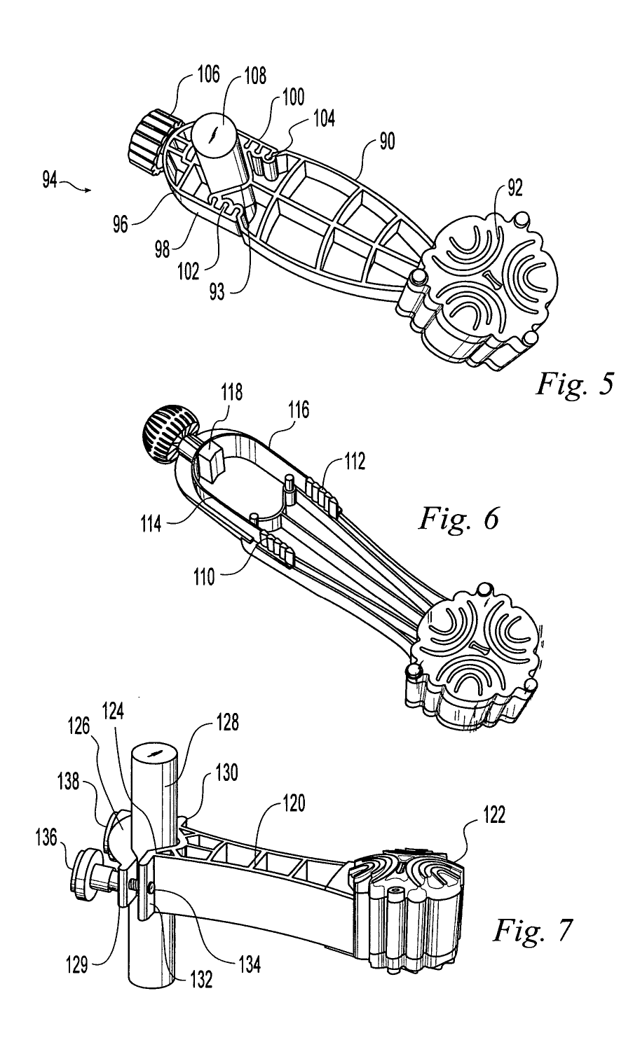

FIG. 5 shows an alternative embodiment with a support arm 90 having a vibrator housing 92 attached at one end and a clamping jaw 93 at its opposite end. The clamping arrangement 94 has a removable jaw member 96 that has opposite legs 98 and 100. Fingers 102 and 104 extend laterally inwardly from the legs 98 and 100 respectively and are slidable into mating slots that open outwardly on opposite sides of the support arm 90. A knob 106 is fixed to a threaded rod which is threadedly engaged to the removable jaw member 96 along the longitudinal axis of the support arm 90. A second and smaller clamping jaw is rotatably secured to the threaded rod so that rotation of the knob 106 and with it the threaded rod causes the rod, and the second clamping jaw carried on its end, to be forced inwardly or outwardly from the chair column 108. To remove the removable jaw member 96, the knob is rotated to back the threaded rod and the jaw it carries away from the column 108 until the removable jaw member is loose enough to be slid vertically, sliding the fingers 102 and 104 out of the mating slots. Attachment is accomplished with the opposite sequence of manipulations.

FIG. 6 illustrates an embodiment that is similar to the embodiment of FIG. 5 except that, instead of the mating fingers and slots on opposite sides of the ends of the legs, the embodiment of FIG. 6 has sawtooth serrations 110 and 112 extending inwardly from legs 114 and 116 of its removable jaw member 118. These sawtooth serrations 110 and 112 are received in mating, outwardly directed sawtooth serrations on opposite sides of the support arm 120. The manipulation of the embodiment is the same as that described for the embodiment of FIG. 5.

FIG. 7 illustrates an embodiment having a support arm 120 with a vibrator housing 122 attached at one end and a concave clamping jaw 124 fixed to its opposite end. A second clamping jaw 126 is oppositely concave for clamping a chair column 128 between the jaws 124 and 126. A pair of flanges 130 and 132 extend outwardly and oppositely from the clamping jaw 124 and each flange has a threaded bore for threadedly receiving a threaded rod, only one threaded rod 134 being visible. The threaded rods pass along opposite sides of the chair column 128 and pass loosely through smooth bores that are formed through a second set of flanges (only one flange 129 being visible) that extend outwardly from opposite side of the second clamping jaw 126. Two knobs 136 and 138 are each fixed to the distal ends of a threaded rod so that, as the knobs and therefore the threaded rods are rotated, the knobs move either toward the support arm 120 to force the second jaw 126 toward the first jaw 124 or away from the support arm, depending upon the direction of rotation of the knobs.

While certain preferred embodiments of the present invention have been disclosed in detail, it is to be understood that various modifications may be adopted without departing from the spirit of the invention.

1. A low frequency transducer apparatus for generating low frequency vibrations in an article of furniture, the apparatus comprising:
(a) a clamp for attachment to a component of an article of furniture;
(b) a support arm attached to and extending from the clamp; and
(c) a mechanical vibrator attached to the arm.

2. An apparatus in accordance with claim 1 wherein the clamp is attached at one end of the arm and the vibrator is attached at the opposite end of the arm.

3. An apparatus in accordance with claim 2 wherein the arm has a length substantially within the range of 1 inch to 12 inches.

4. An apparatus in accordance with claim 3 wherein the arm has a length substantially within the range of 4 inch to 10 inches.

5. An apparatus in accordance with claim 4 wherein the arm has a length substantially within the range of 6 inches to 7 inches.

6. An apparatus in accordance with claim 1 wherein the clamp is a manually operable clamp for attachment to and removal from the article of furniture.

7. An apparatus in accordance with claim 6 wherein the clamp includes a pair of oppositely contoured, concave jaws.

8. An apparatus in accordance with claim 7 wherein the oppositely contoured, concave jaws have an axis about which a component of the furniture article may be clamped, the vibrator having a vibrator axis of vibration substantially parallel to the axis of the jaws.

9. An apparatus in accordance with claim 7, wherein the concave jaws are V-shaped, a first one of the jaws is fixed to the arm and a second one of the jaws is pivotally mounted in the manner of a hinge to the arm at a side of the first jaw.

10. An apparatus in accordance with claim 9 wherein the oppositely contoured, concave jaws have an axis about which a component of the furniture article may be clamped, the vibrator having a vibrator axis of vibration substantially parallel to the axis of the jaws.

11. An apparatus in accordance with claim 9, wherein the clamp further comprises
(a) a cylindrical sleeve fixed to the arm at the side of the first jaw which is opposite the side to which the second jaw is pivotally mounted, the sleeve having a slot formed transversely through the cylindrical sleeve;
(b) a pivot pin pivotally mounted in the sleeve;
(c) a screw threaded rod extending radially from and rotatably engaged to the pivot pin, the rod extending through the slot for movement circularly through an arc of at least 90°;
(d) a manually actuable knob fixed to the end of the rod so that rotation of the knob rotates the rod;
(e) a channel formed near the side of the second jaw distally from the pivotally hinged side, the channel opening away from the sleeve;
(f) a vice jaw pin having a transversely threaded hole threadedly engaging the rod for translation along the rod when the rod is rotated, the vice jaw pin being removably seatable in the channel for tightening the clamp upon sufficient rotation of the rod.

12. An apparatus in accordance with claim 1 wherein the clamp is attached at one end of the arm and the vibrator is attached at the opposite end of the arm, the arm having a bending mode spring constant and the vibrator having a mass, the spring constant and mass being related to provide resonance at the operating, low frequency range of the vibrator.

13. An improved, vibratory chair, the chair including at least one chair leg and having a low frequency transducer vibrator for generating low frequency vibrations attached to the chair, wherein the improvement comprises:
(a) a clamp attached to the chair leg; and
(b) a support arm attached at one end to and extending from the clamp as a cantilever and having the vibrator attached at the opposite end of the arm.

14. A chair in accordance with claim 13 wherein the support arm extends horizontally from the chair leg.

15. A chair in accordance with claim 14 wherein the vibrator has an axis of vibration that is substantially parallel to the chair leg.

16. An apparatus in accordance with claim 14 wherein the arm has a length substantially within the range of 1 inch to 12 inches.

17. An apparatus in accordance with claim 16 wherein the arm has a length substantially within the range of 4 inch to 10 inches.

18. An apparatus in accordance with claim 17 wherein the arm has a length substantially within the range of 6 inches to 7 inches.
